(19) United States
(12) Patent Application Publication
(10) Pub. No.: US 2025/0292536 A1
(43) Pub. Date: Sep. 18, 2025

(54) IMAGE SELECTION DEVICE, IMAGE SELECTION METHOD, AND STORAGE MEDIUM

(71) Applicant: NEC Corporation, Tokyo (JP)

(72) Inventors: Ryuhei ANDO, Tokyo (JP); Takashi SHIBATA, Tokyo (JP)

(73) Assignee: NEC Corporation, Tokyo (JP)

(21) Appl. No.: 19/039,993

(22) Filed: Jan. 29, 2025

(30) Foreign Application Priority Data
Mar. 18, 2024 (JP) 2024-041831

(51) Int. Cl. G06V 10/72; G06V 10/74; G06V 10/762; G06V 10/764; G06V 20/40

(52) U.S. Cl. CPC G06V 10/72; G06V 10/761; G06V 10/762; G06V 20/41; G06V 10/764

(57) ABSTRACT

The image selection device 1X includes a text information acquisition means 30X, a score calculation means 34X, and an image selection means 35X. The text information acquisition means 30X is configured to acquire text information specifying an image to be acquired from an image group. The score calculation means 34X is configured to calculate a score which represents a degree of match between each image of the image group and the text information. The image selection means 35X is configured to select images from the image group by sampling based on a distribution of the score.

### INCORPORATION BY REFERENCE

This application is based upon and claims the benefit of priority from Japanese Patent Application No. 2024-041831, filed on Mar. 18, 2024, the disclosure of which is incorporated herein in its entirety by reference.

### TECHNICAL FIELD

The present disclosure relates to a technical field of an image selection device, an image selection method, and a storage medium for selecting an image.

### BACKGROUND

A system for selecting images based on text information entered by the user is known. For example, Patent Literature 1 discloses a system that refers to an image database where each image data is associated with feature data indicative of the meaning of each image data and that extracts image data related to the text information input by the user to present the extracted image data to the user.

### CITATION LIST

### Patent Literature

Patent Literature 1: JP 2009-64079A

### SUMMARY

When images are selected based on the goodness of fit between the specified text information and each candidate image, images having similar goodness of fit tend to be similar in appearance. Thus, if images are selected from a moving image, successive images in time series will be selected. The images selected in this way have high similarity with one another, and it could be inappropriate, for example, when they are used as training data of a deep learning model or when they are used as a result of image retrieval.

In view of the above-described issues, one object of the present disclosure is to provide an image selection device, an image selection method, and a storage medium capable of suitably performing selection of images.

In an example aspect of the present disclosure, there is provided an image selection device including:
a text information acquisition means configured to acquire text information specifying an image to be acquired from an image group;
a score calculation means configured to calculate a score which represents a degree of match between each image of the image group and the text information; and
an image selection means configured to select images from the image group by sampling based on a distribution of the score.

In an example aspect of the present disclosure, there is provided an image selection method executed by a computer, including:
acquiring text information specifying an image to be acquired from an image group;
calculating a score which represents a degree of match between each image of the image group and the text information; and
selecting images from the image group by sampling based on a distribution of the score.

In an example aspect of the present disclosure, there is provided a storage medium storing a program executed by a computer, the program causing the computer to:
acquire text information specifying an image to be acquired from an image group;
calculate a score which represents a degree of match between each image of the image group and the text information; and
select images from the image group by sampling based on a distribution of the score.

An example advantage according to the present disclosure is to suitably perform a selection of images.

### BRIEF DESCRIPTION OF THE DRAWINGS

FIG. 1 illustrates an outline configuration of an image selection system.

FIG. 2 illustrates a hardware configuration of the image selection system.

FIG. 3 illustrates an example of a functional blocks of the image selection device.

FIG. 4 illustrates an example of a flowchart showing a procedure of process performed by the image selection device.

FIGS. 5A and 5B illustrate graphs showing time variation in the match score of a video.

FIG. 6 illustrates an example of functional blocks of the image selection device.

FIG. 7 illustrates an example of a flowchart showing a procedure of process performed by the image selection device.

FIG. 8 illustrates an example of functional blocks of the image selection device.

FIG. 9 illustrates functional blocks in which an evaluation unit configured to evaluate and select matched images used for machine learning is added to the functional blocks of the image selection device shown in FIG. 8.

FIG. 10 illustrates an example of functional blocks of the image selection device.

FIG. 11 illustrates a block diagram of an image selection device.

FIG. 12 illustrates an example of a flowchart showing a processing procedure of the image selection device.

### EXAMPLE EMBODIMENTS

Hereinafter, example embodiments of an image selection device, an image selection method, and a storage medium will be described with reference to the drawings.

### First Example Embodiment

### (1) System Configuration

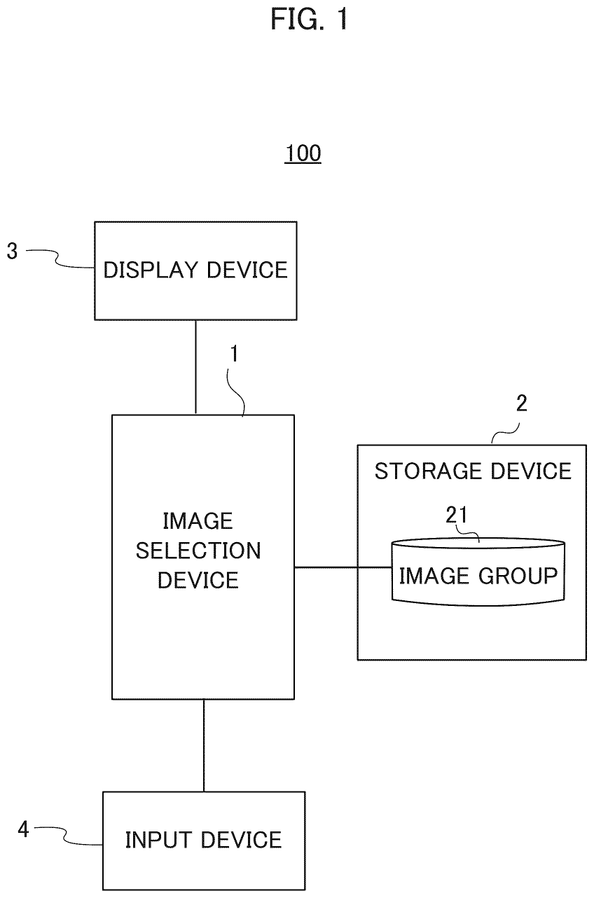

FIG. 1 shows a schematic configuration of an image selection system 100. The image selection system 100 selects images which matches text information from an image group, wherein the text information indicates a category regarding a target action or object of recognition by a deep learning model subjected to machine learning. Thus, the image selection system 100 automates the work necessary to prepare the training data to be used for machine learning of the deep learning model, and suitably reduces the labor required for the work. The image selection system 100 mainly includes an image selection device 1, a storage device 2, a display device 3, and an input device 4.

On the basis of the text information specified by an input signal or the like supplied from the input device 4, the image selection device 1 selects images (also referred to as “matched images”) which match the text information from the image group 21 stored in the storage device 2. The image selection device 1 may display the selected matched images in association with the text information on the display device 3, or may store the matched images in the storage device 2 in association with the text information.

The storage device 2 is one or more memories for storing various information necessary for the image selection device 1 to process data, and stores an image group 21.

The image group 21 is a collection of images (also referred to as “candidate images”) subjected to image selection by the image selection device 1. The image group 21 may be, for example, a sequence of images constituting a video (i.e., image group generated in time series) or may be a database of images. The candidate image includes region(s) of one or more objects.

The storage device 2 may be an external storage device, such as a hard disk, connected to or incorporated in the image selection device 1 or may be a storage medium, such as a portable flash memory. The storage device 2 may be a server device that performs data communication with the image selection device 1. Further, the storage device 2 may be configured by a plurality of devices.

The display device 3 displays information under the control of the image selection device 1. Examples of the display device 3 include a display, a projector, and the like. Upon receiving a display signal supplied from the image selection device 1, the display device 3 displays information based on the received display signal.

The input device 4 is one or more interfaces for receiving a user input that is an external input based on an operation from a user of the image selection system 100, and examples of the input device 4 include a touch panel, a button, a keyboard, and a voice input device. The input device 4 supplies an input signal generated based on the input from the user to the image selection device 1.

The configuration of the image selection system 100 shown in FIG. 1 is an example, and various changes may be made to the configuration. For example, the image selection device 1, the storage device 2, the display device 3, and the input device 4 may be configured integrally by any combination. The image selection system 100 may also include a sound output device such as a speaker. The image selection device 1 may be configured by a plurality of devices. In this case, the plurality of devices constituting the image selection device 1 transmits and receives information necessary for executing the preassigned process among the plurality of devices.

A supplementary description will now be given of the application of the image selection system 100.

Machine learning of a deep learning model for image recognition requires video-based training data. Examples of deep learning models that perform image recognition include a model configured to recognize target objects (such as workpieces) of operation and/or actions of workers (including robots) at construction sites, warehouse sites, retails (customer's behavior histories), or manufacturing sites (assembly sites). In order to raise the recognition accuracy of such a model and to precisely control robots such as an arm robot and a construction machine, it is necessary that the training data contains various positive example data which are images in which actions and/or target objects of recognition are shown.

The images selected by the image selection system 100 may be used as positive example images representing the target of recognition as they are, or may be used in annotation work for finer correctness. In the annotation work, in the case of action recognition, the generation of labels on the action patterns of the objects, bounding boxes of the target objects of recognition, instance segmentations, and the like are carried out based on the input from operators.

After the selection of the matched images, machine learning of the deep learning model is carried out using the matched images or labels generated by the annotation work from the matched imaged, and then action recognition and/or recognition of workpieces using the recognition model built through the machine learning are carried out. Such machine learning and recognition using the deep learning model after the machine learning described above may be performed by the image selection device 1, or may be performed by a device other than the image selection device 1. Furthermore, the image selection device 1 may function as a control device for controlling the operation of the robot or the like. In this case, the control device recognizes the action or object shown in the captured image to control the operation of the target robot of control based on the recognition result. As a result of training the model using the matched images selected by the image selection device 1 as the training data, the recognition accuracy of the model can be improved. Such improvement of the accuracy of recognizing the action and the object allows to precisely control the operation of the controlled object such as a robot.

### (2) Hardware Configuration

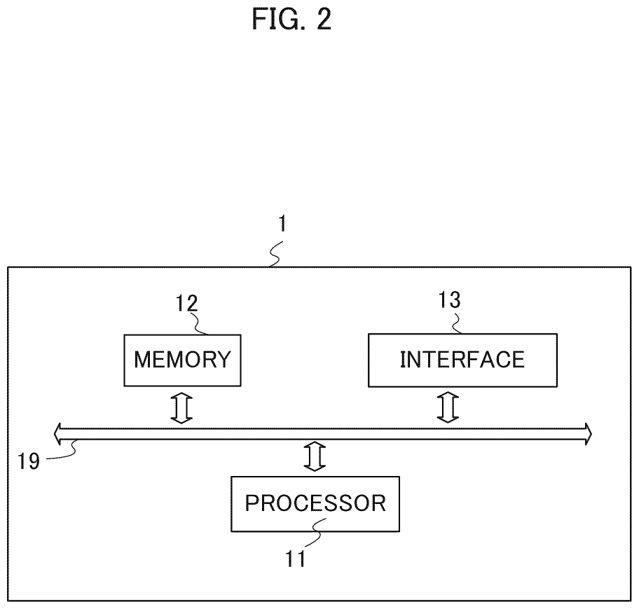

FIG. 2 shows a hardware configuration of the image selection device 1. The image selection device 1 includes a processor 11, a memory 12, and an interface 13 as hardware. The processor 11, memory 12 and interface 13 are connected to one another via a data bus 19.

The processor 11 executes a predetermined process by executing a program stored in the memory 12. The processor 11 is one or more processors such as a CPU (Central Processing Unit), a GPU (Graphics Processing Unit), and a TPU (Tensor Processing Unit). The processor 11 may be configured by a plurality of processors. The processor 11 is an example of a computer.

The memory 12 is configured by various volatile memories and non-volatile memories such as a RAM (Random Access Memory) and a ROM (Read Only Memory). A program for executing various process by the image selection device 1 is stored in the memory 12. The memory 12 is used as a working memory to temporarily store information and the like acquired from the storage device 2. The memory 12 may function as the storage device 2. Instead, the storage device 2 may function as the memory 12 of the image selection device 1. The program executed by the image selection device 1 may be stored in a storage medium other than the memory 12.

The interface 13 is one or more interfaces for electrically connecting the image selection device 1 to other devices. Examples of the interfaces include wireless interfaces, such as network adapters, for transmitting and receiving data to and from other devices wirelessly, and hardware interfaces, such as cables, for connecting to other devices.

The hardware configuration of the image selection device 1 is not limited to the configuration shown in FIG. 2. For example, the image selection device 1 may include at least one of a display device 3 and/or an input device 4. The image selection device 1 may be connected to or incorporate a sound output device such as a speaker.

### (3) Selection of Matched Images

A description will be given of the process regarding the selection of the matched images to be executed by the image selection device 1. In summary, the image selection device 1 calculates a score (also referred to as “match score”) indicating the degree of match (i.e., the goodness of fit) between the text information and each candidate image, and selects the matched image by sampling based on the distribution of the match score. Thus, the image selection device 1 suitably suppresses that a plurality of images similar to each other, such as images aligned in a time series, are biasedly selected as the matched images. Hereafter, the match score shall be an indicator that the higher the value of the match score is, the more the goodness of fit increase. Instead of this example, a match score, indicating that the lower the value of the match score is, the less the goodness of fit become, may be used.

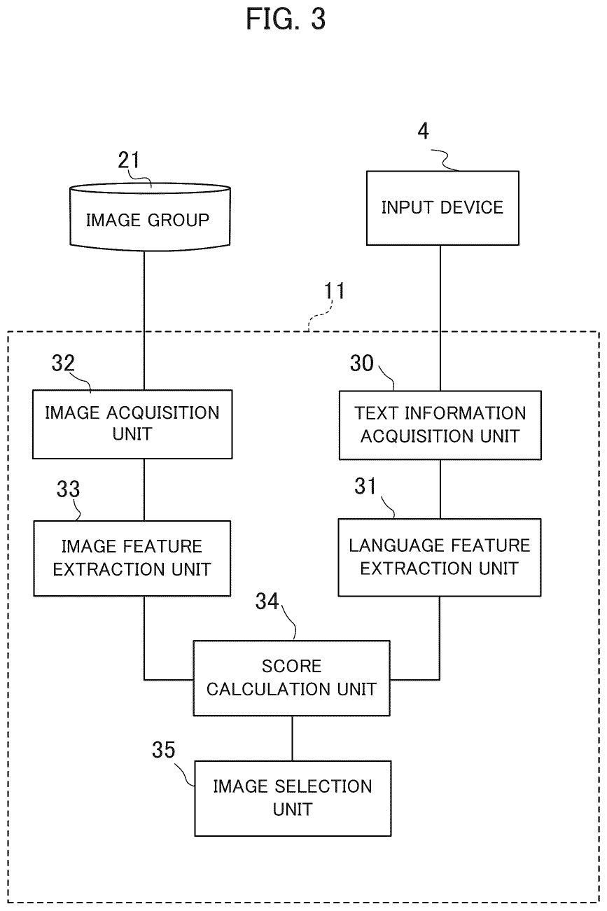

FIG. 3 is an example of functional blocks of the image selection device 1. As shown in FIG. 3, the processor 11 of the image selection device 1 functionally includes a text information acquisition unit 30, a language feature extraction unit 31, an image acquisition unit 32, an image feature extraction unit 33, a score calculation unit 34, and an image selection unit 35. In FIG. 3, blocks for transmitting and receiving data are connected by a solid line, but the combination of blocks for transmitting and receiving data is not limited thereto. The same applies to the drawings of other functional blocks described below.

The text information acquisition unit 30 acquires text information, based on the input signal or the like supplied from the input device 4 via the interface 13. The text information acquisition unit 30 supplies the acquired text information to the language feature extraction unit 31.

The language feature extraction unit 31 extracts the features of the text information supplied from the text information acquisition unit 30 and generates the language features which are the features of the text information. In this case, for example, the language feature extraction unit 31 acquires, as language features, features output by a feature extraction model upon inputting text information to the feature extraction model. The term “features” is a quantitative expression and is data represented in a predetermined tensor format. The feature extraction model described above may be a feature extraction model applied to text information in CLIP (Contrastive Language-Image Pre-training) model, which is a pre-learned image classification model for inferring a pair of image and text information, or may be any feature extraction model applied to text information in VLM (Vision-Language Model). The language feature extraction unit 31 supplies the generated language features to the score calculation unit 34.

The image acquisition unit 32 acquires each candidate image of the image group 21, and supplies the acquired each candidate image to the image feature extraction unit 33. Image features are calculated by the image feature extraction unit 33 for each candidate image of the image group 21.

The image feature extraction unit 33 generates image features, which are features of each candidate image supplied from the image acquisition unit 32. In this case, for example, the image feature extraction unit 33 acquires, as image features, features output by the feature extraction model upon inputting the each candidate image to the feature extraction model. The above-described feature extraction model may be a feature extraction model that is applied to an image in CLIP model that is a prior-learning image classification model configured to infer a pair of an image and text information, or may be any feature extraction model that is applied to an image in VLM. The image feature extraction unit 33 supplies the generated image features to the score calculation unit 34.

The machine learning models used in the language feature extraction unit 31 and the image feature extraction unit 33 is not limited to such machine learning models obtained through zero-shot learning, but may be any machine learning models configured to output the features of input data upon receiving input of image or text information.

The score calculation unit 34 calculates the degree of similarity between the language features supplied from the language feature extraction unit 31 and the image features for each candidate image supplied from the image feature extraction unit 33. In this case, as the above-described “degree of similarity”, the score calculation unit 34 may use an indicator representing an arbitrary degree of similarity calculated through features-to-features comparison. For example, the degree of similarity may be a cosine similarity, or may be a Euclidean distance between the language features and the image features in a common feature space of the language features and the image features.

Then, the score calculation unit 34 considers the above-described degree of similarity calculated for each candidate image as a match score for each candidate image and supplies the match score for each candidate image to the image selection unit 35. The score calculation unit 34 performs a filtering process or/and a normalization process on the calculated degree of similarity as described in the modification to be described later, and the value obtained after these processes may be defined as a match score.

On the basis of the match scores calculated by the score calculation unit 34 for respective candidate images, the image selection unit 35 selects the matched images which are candidate images matching the text information. In this case, for example, the image selection unit 35 probabilistically selects the matched images from the candidate images by weighted random sampling using the match scores. In addition to the weighted random sampling, the image selection unit 35 may use Gibbs sampling after Gaussian fitting of the match scores or the Markov chain Monte Carlo method other than Gibbs sampling, or may perform sampling using Blocked gibbs sampler or collapsed gibbs sampler, which are extended Gibbs sampling methods. Further, in another example, the image selection unit 35 may perform sampling based on Simulated Annealing (annealing method) or an extended ensemble method.

In some embodiments, if the image group 21 is a sequence of images constituting a video (i.e., time-series images), the image selection unit 35 may set a constraint condition such that the time interval (i.e., the number of frames between images) between any two sampled images is equal to or larger than a predetermined threshold value. In this case, the image selection unit 35 calculates the time interval between any two sampled images, and cancels the sampling of at least one of the two images to perform sampling again if the calculated time interval of the two images is less than the predetermined threshold value. The above threshold value is, for example, a predetermined value previously stored in the memory 12 or the storage device 2. Thus, the image selection unit 35 can repeat the sampling so that images closer (that is, become almost the same) to each other on the time axis in the video are not selected as matched images.

Here, each component of the text information acquisition unit 30, the language feature extraction unit 31, the image acquisition unit 32, the image feature extraction unit 33, the score calculation unit 34, and the image selection unit 35 can be realized, for example, by the processor 11 executing a program. In addition, the necessary program may be recorded in any non-volatile storage medium and installed as necessary to realize the respective components. In addition, at least a part of these components is not limited to being realized by a software program and may be realized by any combination of hardware, firmware, and software. At least some of these components may also be implemented using user-programmable integrated circuitry, such as FPGA (Field-Programmable Gate Array) and microcontrollers. In this case, the integrated circuit may be used to realize a program for configuring each of the above-described components. Further, at least a part of the components may be configured by a ASSP (Application Specific Standard Produce), ASIC (Application Specific Integrated Circuit) and/or a quantum processor (quantum computer control chip). In this way, each component may be implemented by a variety of hardware. The above is true for other example embodiments to be described later. Further, each of these components may be realized by the collaboration of a plurality of computers, for example, using cloud computing technology.

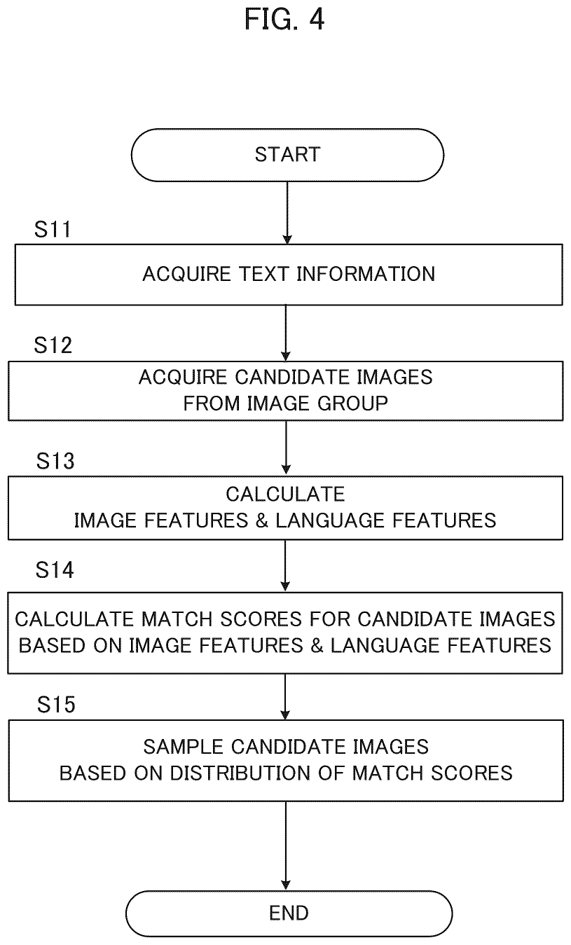

FIG. 4 is an example of a flowchart illustrating a procedure of the process that is executed by the image selection device 1. The image selection device 1 executes the processing of the flowchart shown in FIG. 4 for each text information.

First, the text information acquisition unit 30 of the image selection device 1 acquires text information (step S11). In this case, the text information acquisition unit 30 may acquire the text information on the basis of the input signal supplied from the input device 4 or the like, or may acquire the text information from the storage device 2 or the like in which the text information is stored in advance. Next, the image acquisition unit 32 of the image selection device 1 acquires candidate images from the image group 21 (step S12). In this case, the image acquisition unit 32 acquires respective images of the image group 21 as the candidate images. The process at step S11 and the process at step S12 are in no particular order, and the process at step S12 may be performed before the process at step S11.

Next, the image feature extraction unit 33 of the image selection device 1 computes the image features that are features of the respective candidate images acquired at step S12, and the language feature extraction unit 31 of the image selection device 1 computes the language features that is the features of the text information acquired at step S11 (step S13). Then, on the basis of the image features and the language features computed at step S13, the score calculation unit 34 of the image selection device 1 computes the matching scores of the respective candidate images (step S14). Then, the image selection unit 35 of the image selection device 1 samples the candidate images based on the distribution of the match scores (step S15). Thus, the image selection unit 35 selects a predetermined number of matched images from the candidate images by sampling. Thereafter, the image selection unit 35 may display the predetermined number of matched images on the display device 3 for annotation work or may store them in the storage device 2 in association with the text information acquired at step S11.

A supplementary description will now be given of the effect of the method of selecting matched images in the first example embodiment. A comparative example of determining matched images through comparison between match scores and a predetermined threshold value will be also discussed.

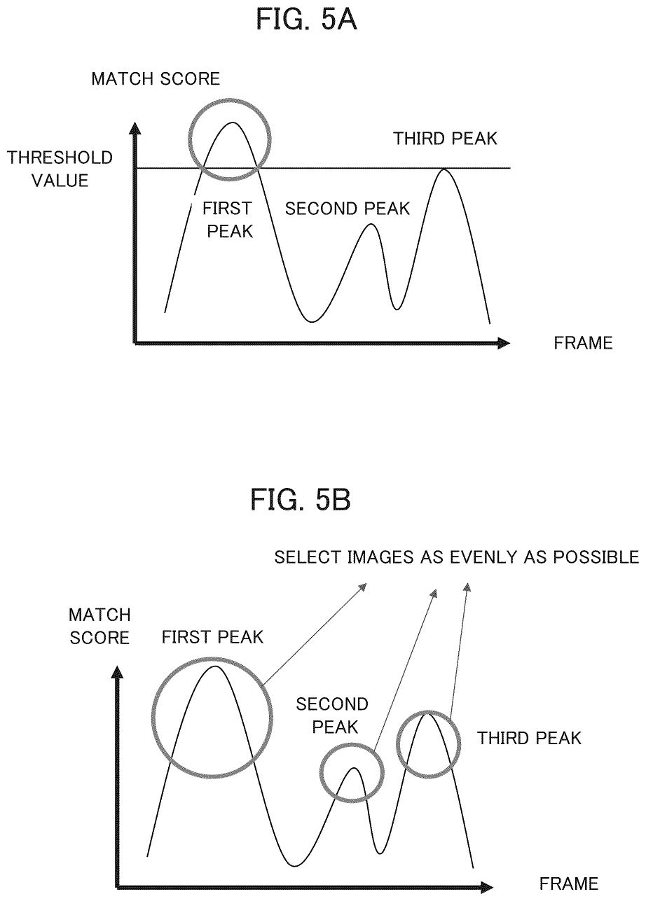

FIGS. 5A and 5B illustrate graphs showing time variation in the match scores of a video in which frames (i.e., images) are successive in time series. In FIG. 5A, the threshold value used in the comparative example is clearly indicated. FIG. 5B illustrates an ideal selection of matched images.

The graph shown in FIG. 5A has three peaks (first peak to third peak) where the match score reaches local maximum values, and only a predetermined section of the first peak exceeds the threshold value. Therefore, in the case of the comparative example, the successive frames belonging to the predetermined section of the first peak will be selected as the matched images. It is noted that a sequence of successive images belonging to a section of a video having time-series correlation constitutes similar images in many cases, and therefore they become similar match scores.

Thus, if the matched images are selected through comparison between match scores and a threshold value as in the comparative example, a sequence of images belonging to a single section is selected intensively as matched images, and the resulting matched images becomes imbalanced. Also, in general, in machine learning to obtain a highly accurate deep learning model, it needs to be done using training data based on images with variation. Therefore, it is preferable that images which are as rich as possible in variation should be selected as matched images.

Taking the above into consideration, in the present embodiment, the image selection device 1 selects the matched images by sampling based on the distribution of the match scores. Thus, as illustrated in FIG. 5B, the image selection device 1 can select the matched images from respective sections of the three peaks (the first peak to the third peak). For example, in Gibbs sampling, probabilistic sampling is performed assuming that there are normally-distributed multiple peaks in the distribution of match scores as shown in FIGS. 5A and 5B. Therefore, by selecting the matched images by Gibbs sampling, the image selection device 1 facilitates selection of matched images from the respective three peaks (the first peak to the third peak) to suitably select a variety of matched images.

### (4) Modifications

Next, modifications suitable for the above-described example embodiment will be described. The following modifications may be applied to the example embodiment described above in any combination.

### First Modification

The image selection device 1 may normalize the match scores among categories after calculating the match scores of candidate images for respective pieces of text information indicating different categories.

In this case, for example, when N pieces of text information indicating different N categories (N is an integer of 2 or more) are used, the score calculation unit 34 of the image selection device 1 computes match scores for the respective pieces of text information per candidate image (that is, N match scores for each candidate image). Then, for each candidate image, the score calculation unit 34 normalizes the match scores (that is, N match scores) among the categories to range from 0 to 1 by using a softmax function or the like.

According to this modification, the image selection device 1 performs normalization of the match score in consideration of the distribution of the match scores of each candidate image among categories, and can select the matched images by sampling based on the distribution of the normalized match scores.

### Second Modification

If the image group 21 is a sequence of images constituting a video, the image selection device 1 may perform smoothing of the match scores on the time axis by applying filtering on the time axis to the match scores of the candidate images.

In this case, the score calculation unit 34 of the image selection device 1 computes the match score for each candidate image, based on the each candidate image and a predetermined number of images adjacent to the each candidate image on the time axis. Then, the score calculation unit 34, for example, sets a time window having a predetermined size for the time corresponding to the each candidate image, and statistically calculates a representative value (including an average, a median, and a maximum value, and the like) of the match scores of the each candidate image corresponding to the time window. Then, the score calculation unit 34 determines that the above-described representative value of the match scores calculated statistically is the match score of the each candidate image at each time.

In some embodiments, the score calculation unit 34 may provide time windows having multiple sizes. In this case, the score calculation unit 34 calculates and collects the above-described representative values (also referred to as “first representative values”) of the match scores for respective time windows, and further calculates the representative value (also referred to as “second representative value”) of the first representative values by further statistical processing. Then, the score calculation unit 34 determines the second representative value as the match score of the each candidate image at each time.

Thus, the score calculation unit 34 can smooth the fluctuation in the match scores among the frames by performing the filtering of the match scores on the time axis. Therefore, the score calculation unit 34 can make the match scores close to the probability distribution assumed in the sampling and correct the distribution of the match scores to be suitable for sampling. The probability distribution assumed in the sampling process is a probability distribution such that frames close to each other on the time axis have similar match scores. For example, in Gibbs sampling, it is assumed that each peak is a normal distribution, the score calculation unit 34 can approximate each peak of the match scores to the normal distribution by the above-described filtering.

In the case of combining the first modification and the second modification, for example, the score calculation unit 34 firstly smooths the match scores in the time series based on the second modification by the filtering, and then performs the normalization of the smoothed match scores among the categories based on the first modification.

### Third Modification

The image selection system 100 may be an image retrieval system that retrieves images which match designated text information and displays the retrieval results.

In this case, once text information is specified based on an input signal or the like generated by the input device 4, the image selection device 1 selects, based on the above-described example embodiment, matched images which match the text information from the image group 21, and displays the selected matched images as image retrieval results on the display device 3. In this case, the image selection device 1 transmits the display signal indicative of the generated retrieval results to the display device 3 via the interface 13, to thereby display the retrieval results on the display device 3. In this case, the retrieval results may be, for example, a list of a predetermined number of candidate images, having top match scores, arranged according to the match scores, or a list of candidate images, having top match scores, arranged according to a criterion other than the match score.

According to this modification, the image selection device 1 can preferably present a variety of matched images to the user as the retrieval results.

### Second Example Embodiment

In the second example embodiment, the image selection device 1 performs clustering of the candidate images on the basis of the image features and selects the matched images from the generated clusters by sampling. Hereinafter, the same components as those in the first example embodiment are appropriately denoted by the same reference numerals, and a description thereof will be omitted. Hereinafter, it is assumed that the image selection system 100 has the configuration shown in FIG. 1, and the image selection device 1 has the hardware configuration shown in FIG. 2.

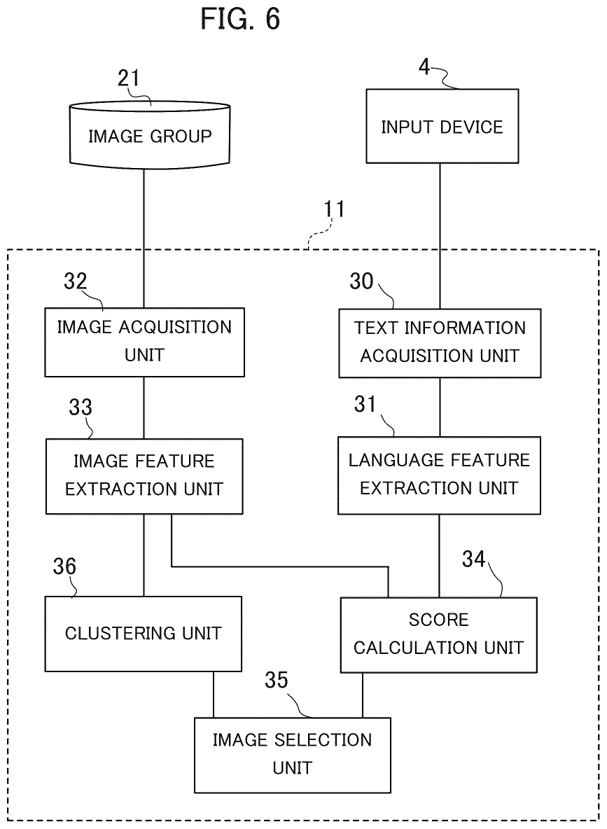

FIG. 6 is an example of functional blocks of the image selection device 1. As shown in FIG. 6, the processor 11 of the image selection device 1 functionally includes a text information acquisition unit 30, a language feature extraction unit 31, an image acquisition unit 32, an image feature extraction unit 33, a score calculation unit 34, an image selection unit 35, and a clustering unit 36. Since the processing by the text information acquisition unit 30, the language feature extraction unit 31, the image acquisition unit 32, the image feature extraction unit 33, and the score calculation unit 34 are the same as those processing in the first example embodiment, the description thereof will not be repeated.

The clustering unit 36 performs clustering of the candidate images on the basis of the image features of each candidate image generated by the image feature extraction unit 33. In this case, the clustering unit 36 may perform clustering of the candidate images based on an arbitrary clustering method (which may be hierarchical clustering or non-hierarchical clustering). Thus, the clustering unit 36 performs clustering so that candidate images with similar appearance belong to the same cluster. The clustering unit 36 may perform the clustering of the candidate images using the candidate images as they are, instead of performing the clustering of the candidate images on the basis of their image features. It is hereafter assumed that M (M is an integer of 1 or more) clusters are generated by clustering.

For each of the M clusters, the image selection unit 35 performs sampling based on the distribution of the match scores described in the first example embodiment, and selects matched image(s) from each of the M clusters (that is, selects M or more matched images in total). In this case, the image selection unit 35 may select at least one matched image from each of the M clusters. The image selection unit 35 may select a predetermined number of matched images uniformly from M clusters, respectively, or may change the number of matched images to be selected according to the cluster. In the latter example, for example, the image selection unit 35 may determine, based on the representative value of the match scores in each cluster, the number of matched images to be selected for each cluster.

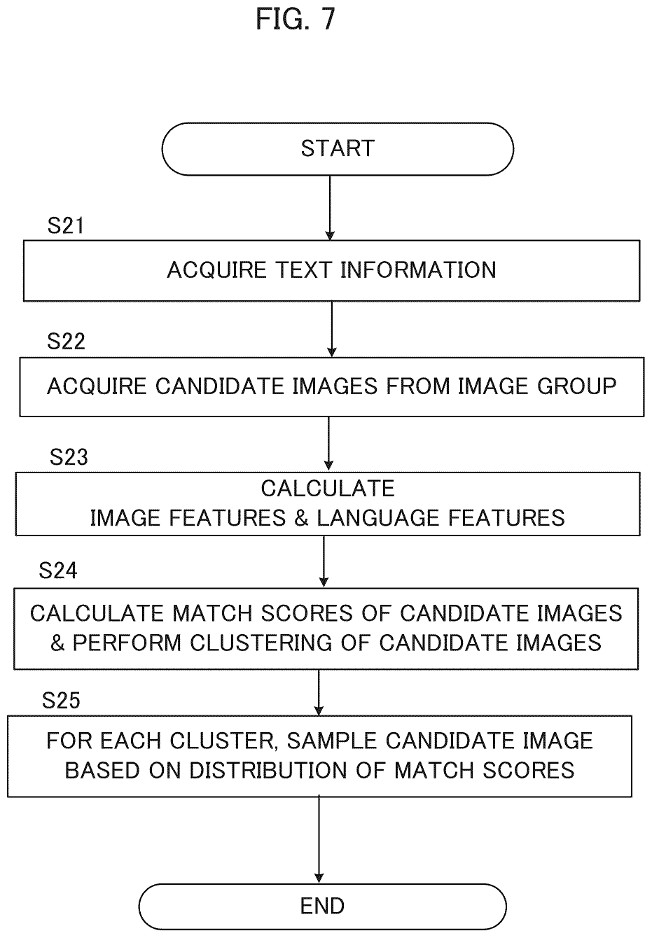

FIG. 7 is an example of a flowchart illustrating a procedure of the process that is executed by the image selection device 1. The image selection device 1 executes the processing of the flowchart shown in FIG. 7 for each piece of text information representing different texts.

First, the text information acquisition unit 30 of the image selection device 1 acquires the text information (step S21). Next, the image acquisition unit 32 of the image selection device 1 acquires the candidate images from the image group 21 (step S22). Next, the image feature extraction unit 33 of the image selection device 1 computes the image features that are the features of the respective candidate images acquired at step S12, and the language feature extraction unit 31 of the image selection device 1 computes the language features that are the features of the text information acquired at step S11 (step S23).

Then, the score calculation unit 34 of the image selection device 1 computes the matching score of each candidate image based on the image features and the linguistic features computed at step S23, and the clustering unit 36 of the image selection device 1 performs the clustering of the candidate images (step S24). Then, the image selection unit 35 of the image selection device 1 samples the candidate images based on the distribution of the match scores for each cluster of the candidate images formed at step S24 (step S25).

According to the second example embodiment, the image selection device 1 can suitably select the matched images with variations by selecting the matched images from the clusters of similar candidate images, respectively. Therefore, as shown in FIG. 5A or FIG. 5B, when distribution of match scores of candidate images constituting a video has a plurality of peaks, it is possible to select matched image(s) from each peak.

### Third Example Embodiment

In the third example embodiment, on the basis of the selected matched images, the image selection device 1 performs learning of the machine learning model used for calculation of the match scores, and performs selection of the matched images again on the basis of the learned machine learning model. Thus, the image selection device 1 selects the matched images which match text information with higher accuracy. Hereinafter, the same components as those in the first example embodiment are appropriately denoted by the same reference numerals, and a description thereof will be omitted. It is hereinafter assumed that the image selection system 100 has the configuration shown in FIG. 1 and the image selection device 1 has the hardware configuration shown in FIG. 2.

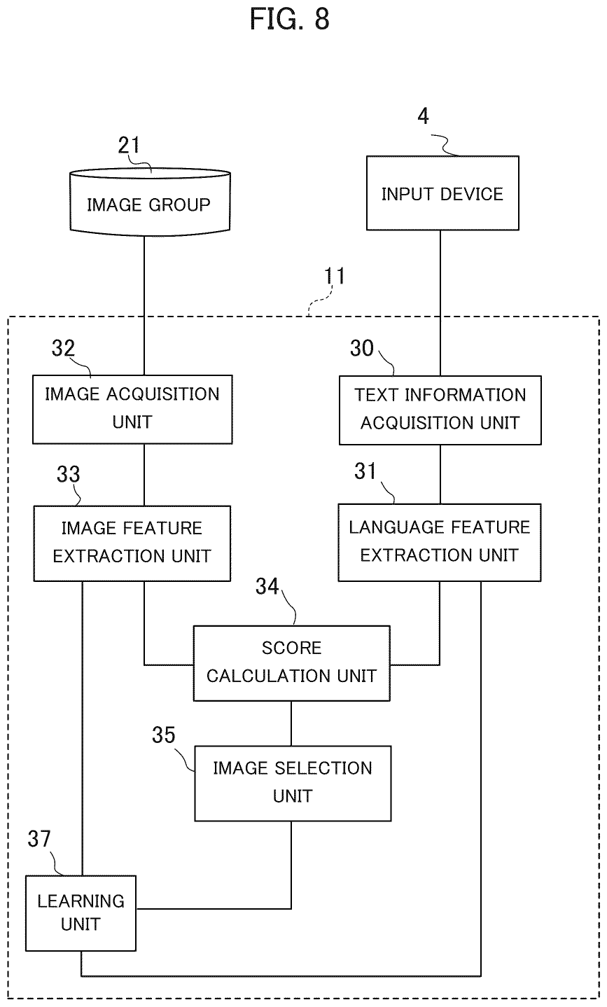

FIG. 8 is an example of functional blocks of the image selection device 1. As shown in FIG. 8, the processor 11 of the image selection device 1 functionally includes a text information acquisition unit 30, a language feature extraction unit 31, an image acquisition unit 32, an image feature extraction unit 33, a score calculation unit 34, an image selection unit 35, and a learning unit 37.

First, the text information acquisition unit 30, the language feature extraction unit 31, the image acquisition unit 32, the image feature extraction unit 33, the score calculation unit 34, and the image selection unit 35 perform the same processing as they do in the first example embodiment. Accordingly, the image selection unit 35 selects a predetermined number of matched images and supplies the selected matched images to the learning unit 37.

The learning unit 37 performs machine learning of the machine learning model used for calculation of the match scores. For example, the learning unit 37 performs machine learning of the feature extraction models used in the language feature extraction unit 31 and the image feature extraction unit 33. In this case, based on the matched images selected by the image selection unit 35 and the corresponding text information, the learning unit 37 updates the parameters of each of the above-described feature extraction models. For example, the learning unit 37 updates the parameters of the feature extraction model used by the language feature extraction unit 31 and the feature extraction model used by the image feature extraction unit 33 so that the loss based on the image features of the matched image and the language features of the corresponding text information is minimized. The algorithm for determining the parameters described above may be any learning algorithm used in machine learning, such as a gradient descent method and an error back propagation method. In addition, any optimization technique such as SGD (Stochastic Gradient Descent) or Adam may be used. The loss function defining the above-described loss may be any loss function such that the lower the degree of similarity between the language features and the image features is, the higher the loss becomes, or any loss function function configured to discriminate whether or not the image and the text information are a correct pair.

After learning of the deep learning model by the learning unit 37, the text information acquisition unit 30, the language feature extraction unit 31, the image acquisition unit 32, the image feature extraction unit 33, the score calculation unit 34, and the image selection unit 35 perform the same processing as in the first example embodiment and select a predetermined number of matched images again. Thus, the image selection unit 35 can select matched images suitable for text information with higher accuracy. The image selection device 1 may repeat the selection of the matched images and the learning of the deep learning model by the learning unit 37 multiple times.

The image selection device 1 may further perform processing for evaluating and selecting the matched image to be used for machine learning by the learning unit 37.

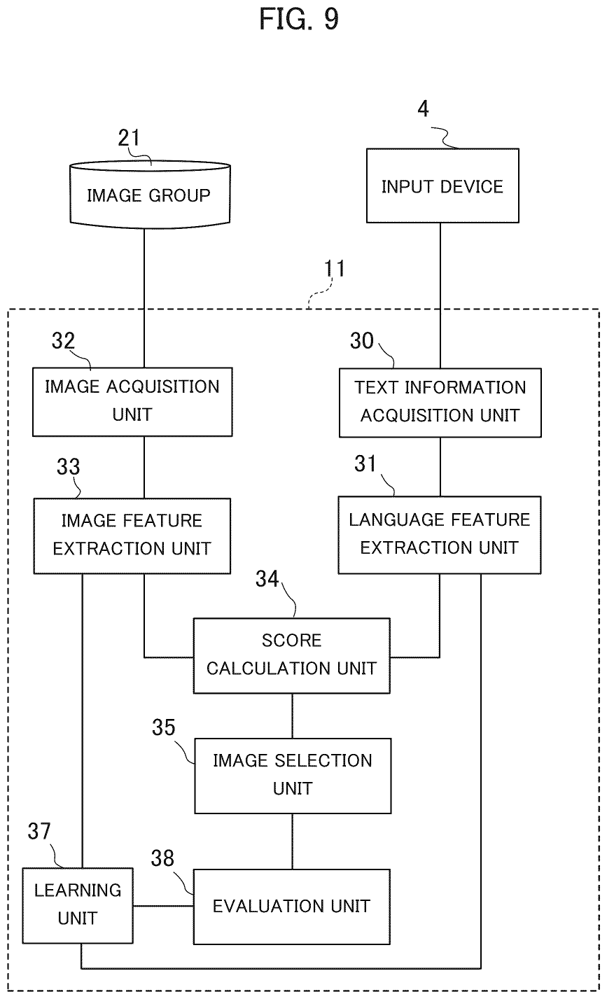

FIG. 9 shows functional blocks in which an evaluation unit 38 for evaluating and selecting matched images used for machine learning by the learning unit 37 is added to the functional block of the image selection device 1 shown in FIG. 8. The evaluation unit 38 evaluates each of the matched images selected by the image selection unit 35 and selects matched images suitable for use in machine learning by the learning unit 37.

In this case, the evaluation unit 38 may perform evaluation and selection of the matched images on the basis of the input signal (i.e., external input) generated by the input device 4 in response to the user's operation, or may automatically perform the evaluation and selection of the matched images. In the former example, for example, the evaluation unit 38 displays the matched images selected by the image selection unit 35 on the display device 3 to receive the input from the user to select matched images suitable for machine learning by the learning unit 37 from the displayed matched images. In the latter example, the evaluation unit 38 uses the image features corresponding to each of the matched images and selects, based on the degree of similarity between these image features, matched images suitable for machine learning by the learning unit 37. For example, the evaluation unit 38 performs clustering based on the degree of similarity described above, and then performs the above-described selection based on the results of the clustering. For example, the evaluation unit 38 may exclude the matched images belonging to a cluster, in which the number of the member(s) of the cluster is less than or equal to a predetermined number, from the matched images used for machine learning by the learning unit 37.

The learning unit 37 updates the parameters of the deep learning model used for calculation of the match scores on the basis of the matched images selected by the evaluation unit 38 and the corresponding text information. After the parameters are updated by the learning unit 37, the text information acquisition unit 30, the language feature extraction unit 31, the image acquisition unit 32, the image feature extraction unit 33, the score calculation unit 34, and the image selection unit 35 perform the same processing as in the first example embodiment. Thus, the image selection unit 35 selects again a predetermined number of matched images.

As described above, the image selection device 1 includes the evaluation unit 38, thereby improving the quality of the training data at the time of re-learning by the learning unit 37 and allowing for performing the selection of the matched images with higher accuracy.

### Fourth Example Embodiment

In the fourth example embodiment, the image selection device 1 detects a partial region for each candidate image and calculates a matching score between the image features and the language features based on the detected partial region. Thus, the image selection device 1 calculates the match score with higher accuracy. Hereinafter, the same components as those in the first example embodiment are appropriately denoted by the same reference numerals, and a description thereof will be omitted. It is hereinafter assumed that the image selection system 100 has the configuration shown in FIG. 1 and that the image selection device 1 has the hardware configuration shown in FIG. 2.

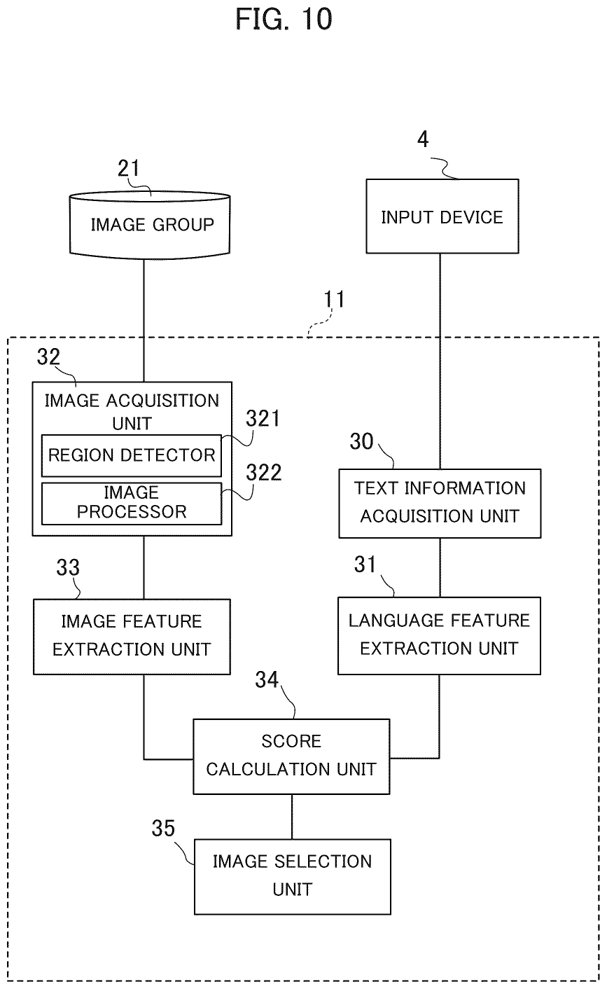

FIG. 10 is an example of functional blocks of the image selection device 1. As shown in FIG. 10, the processor 11 of the image selection device 1 functionally includes, similarly to the processor 11 in the first example embodiment, a text information acquisition unit 30, a language feature extraction unit 31, an image acquisition unit 32, an image feature extraction unit 33, a score calculation unit 34, and an image selection unit 35. The image acquisition unit 32 includes a region detector 321 and an image processor 322.

The region detector 321 detects a region of an object (which may be a person) for each candidate image acquired from the image group 21. In this case, the region detector 321 may perform processing for detecting a region of an object from each candidate image using an arbitrary deep learning model such as instance segmentation.

The image processor 322 performs image processing for each candidate image based on the region detected by the region detection unit 321.

In the first example, the image processor 322 generates a cutout image obtained by cutting out the region detected by the region detector 321 from each candidate image. For example, once the region detector 321 detects a rectangular region, the image processor 322 generates a cutout image obtained by cutting out the rectangular region. In some embodiments, the image processor 322 may generate a cutout image obtained by enlarging and cutting out a region detected by the region detector 321. In the above-described first example, the image feature extraction unit 33 generates the image features of the cutout image generated by the image processor 322.

In the second example, the image processor 322 may provide a channel indicating the region detected by the region detector 321 in the candidate image. If the candidate image is a RGB image, the image processor 322 generates a four-channel image having a channel representing the detected region in addition to the three channels of RGB. In the above-described second example, the image feature extraction unit 33 identifies, based on the channel added by the image processor 322, the pixels used for calculation of the image features and calculates the image features using the values of the identified pixels.

According to the above-described configuration, since the score calculation unit 34 calculates the match scores based on the image features using the region detected by the region detector 321, it is possible to compute the match scores in which the goodness of fit between the text information and the candidate image is more accurately reflected.

### Fifth Example Embodiment

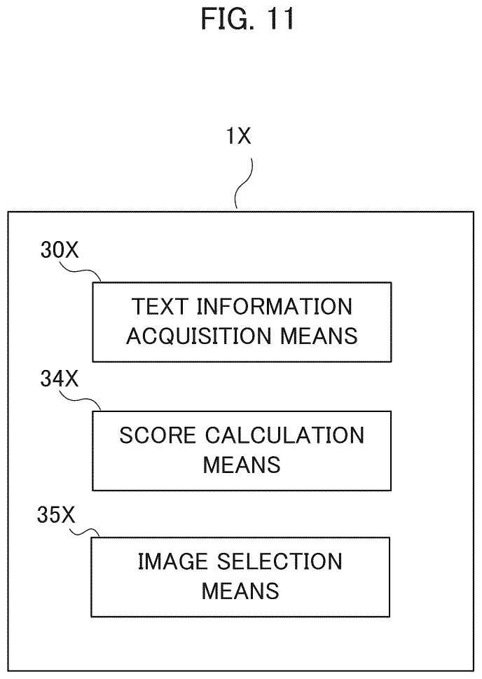

FIG. 11 is a block diagram of an image selection device 1X. The image selection device 1X includes a text information acquisition means 30X, a score calculation means 34X, and an image selection means 35X. The image selection device 1X may be configured by a plurality of devices.

The text information acquisition means 30X is configured to acquire text information specifying an image to be acquired from an image group. Examples of the text information acquisition means 30X include the text information acquisition unit 30 in any of the first example embodiment to the fourth example embodiment.

The score calculation means 34X is configured to calculate a score which represents a degree of match between each image of the image group and the text information. Examples of the score calculation means 34X include the score calculation unit 34 in any one of the first example embodiment to the fourth example embodiment.

The image selection means 35X is configured to select images from the image group by sampling based on a distribution of the score. Examples of the image selection means 35X include the image selection unit 35 in any one of the first example embodiment to the fourth example embodiment.

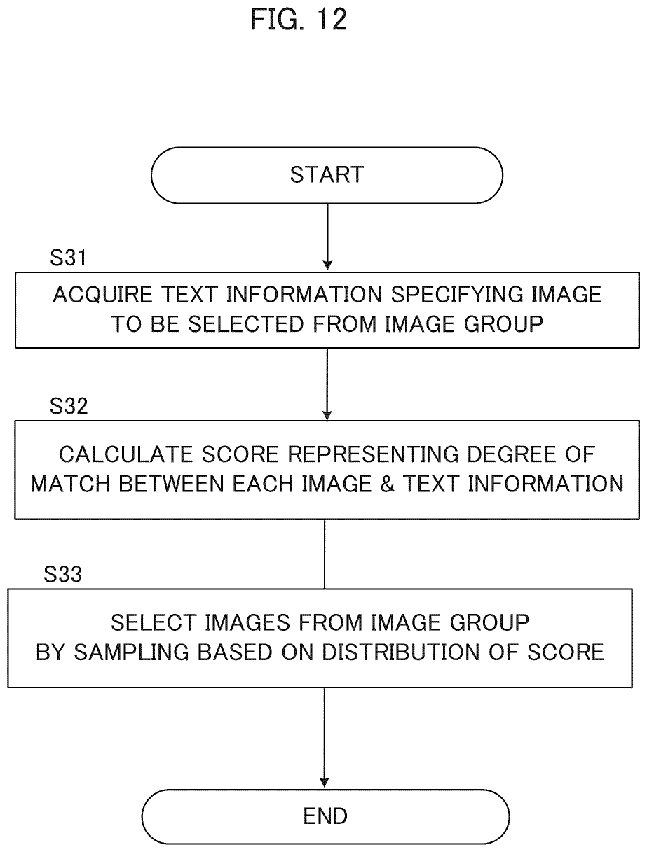

FIG. 12 is an exemplary flowchart illustrating the process of the image selection device 1X. First, the text information acquisition means 30X acquires text information specifying an image to be acquired from an image group (step S31). The score calculation means 34X calculates a score which represents a degree of match between each image of the image group and the text information (step S32). The image selection means 35X selects images from the image group by sampling based on a distribution of the score (step S33).

According to the fifth example embodiment, the image selection device 1X can accurately select images suitable for text information from an image group.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

In addition, some or all of the above-described example embodiments (including modifications, the same shall apply hereinafter) may also be described as follows, but are not limited to the following. Furthermore, within the range defined by the above-described example embodiments, regardless of the device, method, and storage medium described in the following Supplementary Notes, some or all of the configurations described in the following Supplementary Notes may be applied to any hardware, software, system and recording means (including the storage medium) for recording a software.

### Supplementary Note 1

An image selection device comprising:
a text information acquisition means configured to acquire text information specifying an image to be acquired from an image group;
a score calculation means configured to calculate a score which represents a degree of match between each image of the image group and the text information; and
an image selection means configured to select images from the image group by sampling based on a distribution of the score.

### Supplementary Note 2

The image selection device according to Supplementary Note 1,
wherein the image group is a sequence of images constituting a video, and
wherein the image selection means is configured to, upon determining that a time interval between two images selected by the sampling is shorter than a predetermined interval, re-perform the sampling of at least one of the two images.

### Supplementary Note 3

The image selection device according to Supplementary Note 1 or 2,
wherein the score calculation means is configured to
   perform clustering of the image group and
   perform the sampling for each cluster generated by the clustering.

### Supplementary Note 4

The image selection device according to any one of Supplementary Notes 1 to 3,
wherein the image group is a sequence of images constituting a video, and
wherein the score calculation means is configured to calculate the score of each image of the sequence, based on the each image and a predetermined number of images adjacent to the each image in the sequence.

### Supplementary Note 5

The image selection device according to any one of Supplementary Notes 1 to 4,
wherein the text information acquisition means is configured to acquire plural pieces of the text information indicating plural categories, and
wherein the score calculation means is configured to, for each image of the image group, normalize the scores among the plural categories.

### Supplementary Note 6

The image selection device according to Supplementary Note 1,
wherein the at least one processor is configured to
   detect a region of an object from each image of the image group, and
   calculate the score based on the region of the object and the text information.

### Supplementary Note 7

The image selection device according to any one of Supplementary Notes 1 to 6, further comprising:

a language feature extraction means configured to extract language features which are features of the text information; and
an image feature extraction means configured to extract image features which are features of each image of the image group,
wherein the score calculation means is configured to calculate the score of each image of the image group, based on the image features of the each image of the image group and the language features.

### Supplementary Note 8

The image selection device according to any one of Supplementary Notes 1 to 7, further comprising
a learning means configured to perform machine learning of a machine learning model used in calculation of the score,
wherein the image selection means is configured to select the images from the image group by sampling based on the distribution of the score which is calculated based on the machine learning model after the machine learning.

### Supplementary Note 9

An image selection method executed by a computer, comprising:
acquiring text information specifying an image to be acquired from an image group;
calculating a score which represents a degree of match between each image of the image group and the text information; and
selecting images from the image group by sampling based on a distribution of the score.

### Supplementary Note 10

A storage medium storing a program executed by a computer, the program causing the computer to:
acquire text information specifying an image to be acquired from an image group;
calculate a score which represents a degree of match between each image of the image group and the text information; and
select images from the image group by sampling based on a distribution of the score.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. Each example embodiment can be appropriately combined with other example embodiments. All Patent and Non-Patent Literatures mentioned in this specification are incorporated by reference in its entirety.

### DESCRIPTION OF REFERENCE NUMERALS

1, 1X Image selection device

2 Storage device

3 Display device

4 Input device

11 Processor

12 Memory

13 Interface

21 Image group

100 Image selection system

What is claimed is:

1. An image selection device comprising:
at least one memory configured to store instructions; and
at least one processor configured to execute the instructions to:
acquire text information specifying an image to be acquired from an image group;
calculate a score which represents a degree of match between each image of the image group and the text information; and
select images from the image group by sampling based on a distribution of the score.

2. The image selection device according to claim 1,
wherein the image group is a sequence of images constituting a video, and
wherein the at least one processor is configured to, upon determining that a time interval between two images selected by the sampling is shorter than a predetermined interval, re-perform the sampling of at least one of the two images.

3. The image selection device according to claim 1,
wherein the at least one processor is configured to
perform clustering of the image group and
perform the sampling for each cluster generated by the clustering.

4. The image selection device according to claim 1,
wherein the image group is a sequence of images constituting a video, and
wherein the at least one processor is configured to calculate the score of each image of the sequence, based on the each image and a predetermined number of images adjacent to the each image in the sequence.

5. The image selection device according to claim 1,
wherein the at least one processor is configured to
acquire plural pieces of the text information indicating plural categories, and
for each image of the image group, normalize the scores among the plural categories.

6. The image selection device according to claim 1,
wherein the at least one processor is configured to
detect a region of an object from each image of the image group, and
calculate the score based on the region of the object and the text information.

7. The image selection device according to claim 1,
wherein the at least one processor is configured to
extract language features which are features of the text information,
extract image features which are features of each image of the image group, and
calculate the score of the each image of the image group, based on the image features of the each image of the image group and the language features.

8. The image selection device according to claim 1,
wherein the at least one processor is configured to
perform, using the selected images, machine learning of a machine learning model used in calculation of the score, and
select the images again from the image group by sampling based on the distribution of the score which is calculated based on the machine learning model after the machine learning.

9. An image selection method executed by a computer, comprising:
acquiring text information specifying an image to be acquired from an image group;
calculating a score which represents a degree of match between each image of the image group and the text information; and
selecting images from the image group by sampling based on a distribution of the score.

10. A non-transitory computer readable storage medium storing a program executed by a computer, the program causing the computer to:
acquire text information specifying an image to be acquired from an image group;
calculate a score which represents a degree of match between each image of the image group and the text information; and
select images from the image group by sampling based on a distribution of the score.
